(19) United States
(12) Patent Application Publication
(10) Pub. No.: US 2026/0070497 A1
(43) Pub. Date: Mar. 12, 2026

(54) IN-VEHICLE BRACKET

(71) Applicant: NIFCO INC., Yokosuka-shi, Kanagawa (JP)

(72) Inventors: Wenhe JIANG, Yokosuka-shi, Kanagawa (JP); Jumpei HORIKAWA, Yokosuka-shi, Kanagawa (JP)

(21) Appl. No.: 19/106,211

(22) PCT Filed: Aug. 9, 2023
(86) PCT No.: PCT/JP2023/029161

§ 371 Date: Feb. 25, 2025

(30) Foreign Application Priority Data
Sep. 29, 2022 (JP) 2022-155911

(51) Int. Cl. B60R 11/04; B60R 11/00; B60R 13/06

(52) U.S. Cl. CPC B60R 11/04; B60R 2011/0003; B60R 2011/0043; B60R 13/06

(57) ABSTRACT

An in-vehicle bracket for attaching an in-vehicle device to an attachment panel includes: a bracket body section; and a seal section, including soft material, integrated with the bracket body section. The bracket body section includes: a flange part including an attachment part for allowing the in-vehicle device to be attached to the attachment part; and a leg part including a fastening part for attaching the leg part to the attachment panel, the leg part extending from the flange part. The seal section covers the flange part and expands around the flange part, and includes: a waterproof part around the flange part to effect waterproofing between the flange part and the attachment panel; and a crimp part having an attachment hole for attaching the in-vehicle device to the attachment part, the crimp part being around the attachment hole for waterproofing between the flange part and the in-vehicle device.

### FIELD

The present disclosure relates to an in-vehicle bracket for attaching an in-vehicle device to an attachment panel.

### BACKGROUND

In-vehicle devices, such as an in-vehicle camera for an electronic inner mirror, an in-vehicle camera for back monitoring, and a nozzle for camera cleaning, are each attached to a vehicle through an in-vehicle bracket, An example of such an in-vehicle bracket includes a plastic section and an elastomer section (for example, refer to Patent Literature 1).

The plastic section has a cylindrical shape with a lid and includes a lid part and a flange part. The lid part and the flange part each have a through hole, An in-vehicle camera is inserted through the through hole of the lid part and then is fastened to the lid part with fastening screws. The plastic section is releasably secured to a vehicle body metal plate due to an attachment claw inserted through the through hole of the flange part.

The elastomer section is integrally molded with the flange part such that the gap between an inner wall that defines the through hole of the flange part and the attachment claw is occluded. The elastomer section occludes the gap between the flange part and the vehicle body metal plate along the outer circumference of the plastic section. The elastomer section prevents water from entering through the through hole of the flange part and water from entering through the gap between the flange part and the vehicle body metal plate.

### CITATION LIST

### Patent Literature

Patent Literature 1: Japanese Patent Application Laid-Open No. 2012-35693

### SUMMARY

### Technical Problem

Regarding the above-described in-vehicle bracket, the in-vehicle camera is screwed and secured to the lid part of the plastic section. Since the plastic section and the in-vehicle camera are fastened with the fastening screw, gaps exist between a fastening screw and the plastic section, between the plastic section and the in-vehicle camera, and between the in-vehicle camera and a fastening screw. Such gaps due to the fastening between the plastic section and the in-vehicle camera tend to allow water to enter through the gaps, in comparison to any gap occluded by the elastomer section. Thus, the sealing performance of such an in-vehicle bracket interposed between a vehicle body metal plate and an in-vehicle device still leaves room for improvement.

### Solution to Problem

According to an aspect of the present disclosure, an in-vehicle bracket is intended for attaching an in-vehicle device to an attachment panel of a vehicle and includes: a bracket body section; and a seal section made of soft material, the seal section being integrated with the bracket body section. The bracket body section includes: a flange part including an attachment part configured to allow the in-vehicle device to be attached to the attachment part; and a leg part including a fastening part configured to attach the leg part to the attachment panel, the leg part extending from the flange part. The seal section is configured to cover the flange part and expand around the flange part, and includes: a waterproof part disposed around the flange part to effect waterproofing between the flange part and the attachment panel; and a crimp part having an attachment hole for attaching the in-vehicle device to the attachment part, the crimp part being disposed to effect, around the attachment hole, waterproofing between the flange part and the in-vehicle device.

According to the above configuration, the in-vehicle bracket is interposed between the attachment panel and the in-vehicle device. The waterproof part of the in-vehicle bracket effects waterproofing between the flange part and the attachment panel. The attachment hole of the in-vehicle bracket enables attachment of the in-vehicle device to the bracket body section. In addition, the attachment hole of the in-vehicle bracket is disposed to the seal section such that the seal section effects waterproofing between the flange part and the in-vehicle device. As above, the seal section integrated with the bracket body section effects waterproofing between the flange part and the attachment panel and between the flange part and the in-vehicle device. In particular, since the seal section effects waterproofing between the flange part and the in-vehicle device, the sealing performance of the in-vehicle bracket is high.

In the in-vehicle bracket, the crimp part and the waterproof part in the seal section may be integrally formed. According to this configuration, a gap is hardly formed between the bracket body section and the seal section. Thus, the sealing performance between the bracket body section and the seal section is high. In addition, the in-vehicle bracket is easily handled, in comparison to a case where the bracket body section is a member separate from the seal section. Then, since the part including the attachment hole and the waterproof part are integrated together, the in-vehicle bracket is more easily handled.

In the in-vehicle bracket, the crimp part may be disposed over an entire circumference of the attachment hole and may protrude to be crimped to the in-vehicle device. According to this configuration, the waterproofing between the in-vehicle device and the flange part is enhanced by the crimp part.

In the in-vehicle bracket, the waterproof part may be disposed closer to the flange part than the fastening part in an extending direction of the leg part. According to this configuration, since the waterproof part is disposed closer to the flange part than the fastening part, the waterproof part is easily pressed against the surface of the attachment panel with the in-vehicle bracket attached to the attachment panel. Thus, the sealing performance due to the waterproof part between the flange part and the attachment panel is high.

In the in-vehicle bracket, the waterproof part may include: a lip base part joined to the bracket body section; and a lip distal part extending outward from the lip base part with respect to the bracket body section. Then, the lip distal part has a face for contact with the attachment panel and the face may be provided with no parting line, and a boundary between the lip base part and the lip distal part may include an annular parting line that surrounds the flange part in a portion that the waterproof part has to face the attachment panel.

According to the above configuration, the face for contact with the attachment panel in the lip distal part includes no parting line. Thus, the sealing performance due to the waterproof part between the flange part and the attachment panel is higher in comparison to a case where the lip distal part includes a parting line. In addition, the boundary between the lip base part and the lip distal part is the annular parting line. Thus, even with the waterproof part having an undercut shape, for demolding the lip distal part, forced ejection, such as ejection of the lip distal part from the mold along the outer shape of the lip distal part, can be performed.

In the in-vehicle bracket, a portion to face the attachment panel may include parting lines arranged side by side in a circumferential direction of the flange part.

According to the above configuration, even with the waterproof part having an undercut shape, for demolding the lip base part, sliding of the divided molds along the outer shape of the lip base part can be performed. Thus, a production method suitable for forced ejection of the lip distal part can be employed for the lip base part. Thus, a reduction is made in design load for the lip distal part that requires forced ejection.

In the in-vehicle bracket, the waterproof part may include: a lip base part jointed to the bracket body section; and a lip distal part extending outward from the lip base part with respect to the bracket body section, and a joint part of the lip base part to the bracket body section may include alternate protrusions and recesses in a circumferential direction of the flange part.

According to the above configuration, in response to the number of alternate protrusions and recesses, the joint part of the lip base part increases the area of contact with the bracket body section. Thus, an increase is made in the strength at which the waterproof part is joined to the bracket body section.

The in-vehicle bracket may have a configuration in which the leg part includes a plurality of stoppers arranged side by side in a circumferential direction of the leg part, the stoppers protruding outward from an outer circumferential face of the leg part, the stoppers being configured to determine a relative position of the leg part to a surface of the attachment panel, the waterproof part is a lip part including: a lip base part jointed to the bracket body section; and a lip distal part extending outward from the lip base part with respect to the bracket body section, the leg part includes a reception part provided all over in the circumferential direction of the leg part, the reception part extending to the lip base part, and the stoppers do not extend to the lip base part with the reception part extending to the lip base part, whereby a leading end of the reception part is disposed outside leading ends of the stoppers.

According to the above configuration, since the lip base part is away outward from the stoppers, the boundary between the lip base part and the leg part is determined all over in the circumferential direction by the reception part. As a result, the base end in the bendable area of the lip part is determined all over in the circumferential direction by the reception part. In addition, in a case where the attachment panel abuts on the stoppers, the interval in the up-down direction between the attachment panel and the lip base part is constant all over in the circumferential direction. Thus, the stress against bending acting on the lip base part is inhibited from varying in the circumferential direction, so that the surface pressure acting on the lip distal part is uniform in the circumferential direction while being inhibited from partially reducing in the circumferential direction.

### Advantageous Effects of Invention

The above-described in-vehicle bracket enhances the sealing performance between the attachment panel and the in-vehicle device.

### BRIEF DESCRIPTION OF DRAWINGS

FIG. 1 is a perspective view of an in-vehicle bracket, viewed from a side counter to an attachment part, according to a first embodiment.

FIG. 2 is a perspective view of the in-vehicle bracket to which an in-vehicle device is attached.

FIG. 3 is a plan view illustrating the configuration of a seal section that faces an attachment panel.

FIG. 4 is a partially enlarged view illustrating part of the seal section in an enlargement manner.

FIG. 5 is a sectional view of the in-vehicle bracket attached to the attachment panel.

FIG. 6 is a process view illustrating demolding of the in-vehicle bracket.

FIG. 7 is a process view illustrating demolding of the in-vehicle bracket.

FIG. 8 is a process view illustrating demolding of the in-vehicle bracket.

FIG. 9 is a sectional view of an in-vehicle bracket according to a second embodiment.

### DESCRIPTION OF EMBODIMENTS

### First Embodiment

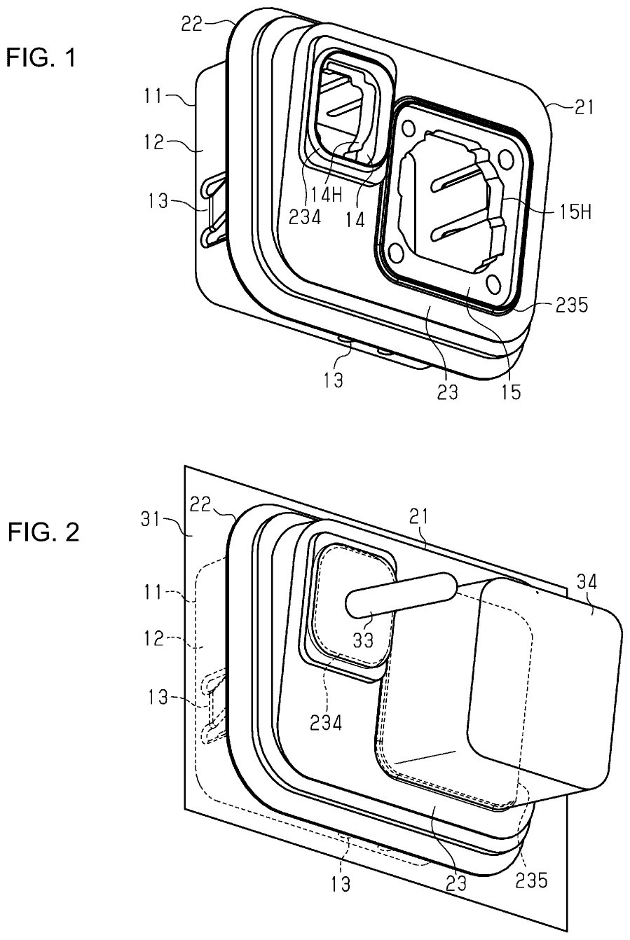

An in-vehicle bracket according to a first embodiment will be described with reference to FIGS. 1 to 8.

### In-Vehicle Bracket

As illustrated in FIG. 1, the in-vehicle bracket includes a bracket body section 11 made of hard resin and a seal section 21 made of soft material. The bracket body section 11 and the seal section 21 in the in-vehicle bracket are integrated together. The in-vehicle bracket may be a double-molded product resulting from integral formation of the bracket body section 11 and the seal section 21 or may be an insert-molded product resulting from molding of the seal section 21 to the bracket body section 11. The in-vehicle bracket may be a crimp-molded product resulting from thermal joining of the seal section 21 to the bracket body section 11.

As an example of the hard resin forming the bracket body section 11, at least one type is selected from the group consisting of polybutylene terephthalate (PBT), polyamides (PA), and polyoxymethylene (POM). The hard resin may be a glass-fiber-reinforced resin containing glass fiber.

The soft material forming the seal section 21 may be a thermoplastic elastomer softer than the constituent material of the bracket body section 11, ethylene propylene rubber (EPDM), or silicone rubber. As an example of the thermoplastic elastomer, at least one type is selected from the group consisting of ester-based elastomers, amide-based elastomers, olefin-based elastomers, styrene-based elastomers, and polyvinyl chloride-based elastomers.

### Bracket Body Section 11

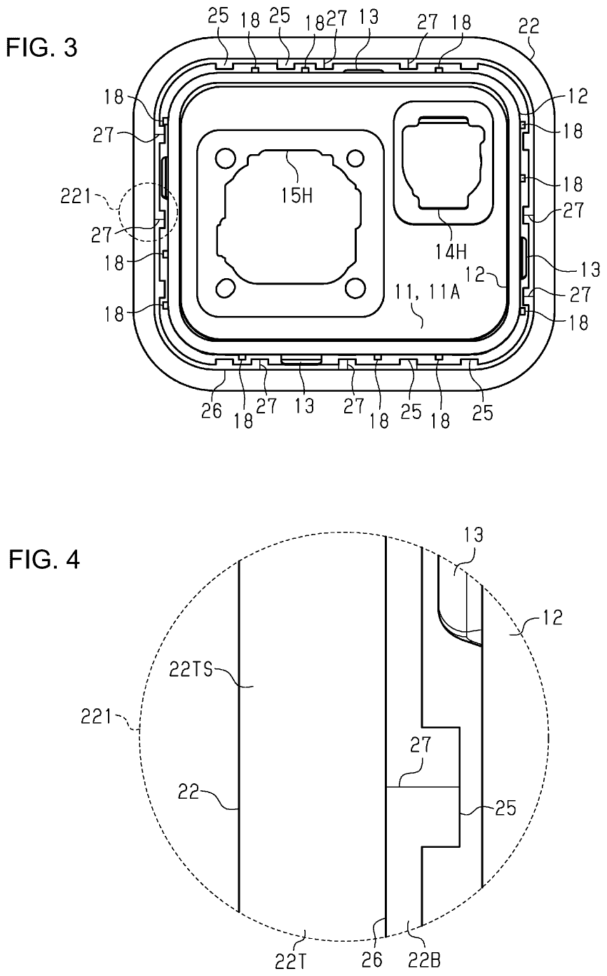

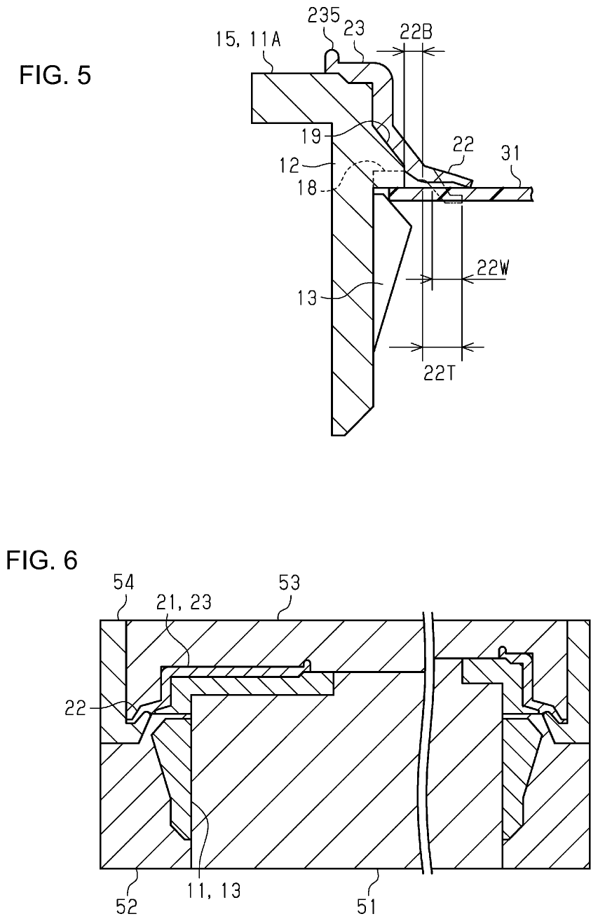

The bracket body section 11 includes a flange part 11A (refer to FIG. 3) and a leg part 12. The bracket body section 11 includes a fastening part 13 and a stopper 18 that are provided to the leg part 12 (refer to FIGS. 4 and 5). The bracket body section 11 includes a first attachment part 14 and a second attachment part 15 that are provided to the flange part 11A.

The leg part 12 is rectangularly cylindrical in shape. The leg part 12 includes a plurality of the fastening parts 13 and two stoppers 18 for each fastening part 13 (refer to FIG. 4). The fastening parts 13 are each shaped like a claw and protrude outward from the leg part 12. The fastening parts 13 each have a shape of a cantilever able to bend inside the cylindrical leg part 12. In order to insert the leg part 12 into an attachment panel 31 of a vehicle, the fastening parts 13 bend such that the leg part 12 passes through an insertion hole of the attachment panel 31. The fastening parts 13 each have, at the leading end of its cantilever, a slope that protrudes outward from the leg part 12 gradually as closer to the leading end of the leg part 12 (refer to FIG. 5).

The stoppers 18 are dispersed in the circumferential direction of the leg part 12. The stoppers 18 are each a protrusion protruding outward from the outer circumferential face of the leg part 12. The stoppers 18 are each disposed closer to the flange part 11A than the corresponding fastening part 13 in the extending direction of the leg part 12. Each fastening part 13 and each corresponding stopper 18 form a gap having a thickness corresponding to the thickness of the attachment panel 31 in the direction in which the leg part 12 extends, between the slope of the fastening part 13 and the corresponding stopper 18. The attachment panel 31 through which the leg part 12 is inserted abuts on the stoppers 18 through the surface of the attachment panel 31. The slope of each fastening part 13 inserted through the insertion hole of the attachment panel 31 presses the back face of the attachment panel 31 to the corresponding stopper 18 while the corresponding fastening part 13 is recovering from the bend, Thus, the leg part 12 is positioned to the attachment panel 31.

The flange part 11A is plate-shaped and extends inward from the leg part 12. The surface of the flange part 11A faces a nozzle 33 for camera cleaning and an in-vehicle camera 34. The back face of the flange part 11A is opposite to the surface of the flange part 11A and faces inside the leg part 12.

The first attachment part 14 is disposed on the surface of the flange part 11A. The first attachment part 14 is plate-shaped and frames a first insertion hole 14H. The first insertion hole 14H penetrates through the flange part 11A of the bracket body section 11. The first insertion hole 14H allows the nozzle 33 for camera cleaning as an exemplary in-vehicle device to be inserted therethrough (refer to FIG. 2). The first attachment part 14 is exposed outward from the in-vehicle bracket through the seal section 21. The nozzle 33 for camera cleaning is attached to the first attachment part 14. The nozzle 33 for camera cleaning is positioned to the first attachment part 14, for example, due to a locking claw of the nozzle 33 for camera cleaning.

The second attachment part 15 is disposed on the surface of the flange part 11A. The second attachment part 15 is plate-shaped and frames a second insertion hole 15H. The second insertion hole 15H penetrates through the flange part 11A of the bracket body section 11. The second insertion hole 15H allows the in-vehicle camera 34 as an exemplary in-vehicle device to be inserted therethrough (refer to FIG. 2). The second attachment part 15 is exposed outward from the in-vehicle bracket through the seal section 21. The in-vehicle camera 34 is attached to the second attachment part 15. The in-vehicle camera 34 is positioned to the second attachment part 15, for example, due to a locking claw of the in-vehicle camera 34.

### Seal Section 21

As illustrated in FIG. 1, the seal section 21 covers the surface of the flange part 11A and expands around the flange part 11A as a shape. The seal section 21 includes a lip part 22 as an exemplary waterproof part and a body seal part 23.

The lip part 22 is a tongue-like body having an undercut shape. The lip part 22 surrounds the leg part 12 all over in the circumferential direction of the leg part 12. The lip part 22 protrudes from the outer circumferential face of the leg part 12 to the outside of the leg part 12 and protrudes in a direction at an angle to the extending direction of the leg part 12.

The body seal part 23 covers the flange part 11A such that the entire circumference of the first attachment part 14 and the entire circumference of the second attachment part 15 are framed by the body seal part 23. The body seal part 23 includes a first crimp part 234 and a second crimp part 235.

The first crimp part 234 protrudes outward from the body seal part 23 along the thickness direction of the body seal part 23. The first crimp part 234 serves as a protrusion that frames the first attachment part 14. The first crimp part 234 serves as an opening edge that frames the entire circumference of a first attachment hole penetrating through the body seal part 23. The first attachment part 14 is exposed from the seal section 21 through the first attachment hole that the first crimp part 234 sections.

As illustrated in FIG. 2, the amount of protrusion of the first crimp part 234 is set such that, when the nozzle 33 for camera cleaning is positioned to the first attachment part 14, the first crimp part 234 is squeezed and crimped by the nozzle 33 for camera cleaning in the direction in which the first crimp part 234 protrudes. Thus, the first crimp part 234 effects waterproofing between the nozzle 33 for camera cleaning and the flange part 11A of the bracket body section 11.

Referring back to FIG. 1, the second crimp part 235 protrudes outward from the body seal part 23 along the thickness direction of the body seal part 23. The second crimp part 235 serves as a protrusion that frames the second attachment part 15. The second crimp part 235 serves as an opening edge that frames the entire circumference of a second attachment hole penetrating through the body seal part 23. The second attachment part 15 is exposed from the seal section 21 through the second attachment hole that the second crimp part 235 sections.

As illustrated in FIG. 2, the amount of protrusion of the second crimp part 235 is set such that, when the in-vehicle camera 34 is positioned to the second attachment part 15, the second crimp part 235 is squeezed and crimped by the in-vehicle camera 34 in the direction in which the second crimp part 235 protrudes. Thus, the second crimp part 235 effects waterproofing between the in-vehicle camera 34 and the flange part 11A of the bracket body section 11.

### Lip Part 22

FIG. 3 illustrates a plan structure of the in-vehicle bracket viewed from the side counter to the back face of the flange part 11A. FIG. 4 illustrates a portion 221 of the lip part 22 viewed from the side counter to the back face of the flange part 11A. That is, FIG. 4 illustrates, in an enlargement manner, a portion that is included in the lip part 22 and faces the attachment panel 31.

As illustrated in FIG. 3, the lip part 22 includes a joint part 25, a first parting line 26, and a second parting line 27.

The joint part 25 is a portion that is included in the lip part 22 and is joined to the leg part 12, The joint part 25 includes alternate protrusions and recesses in the circumferential direction of the flange part 11A. The leg part 12 has its outer circumferential face provided with repeated recesses in the circumferential direction of the flange part 11A. The joint part 25 corresponds to the boundary between the lip part 22 and the outer circumferential face of the leg part 12, which is provided with the recesses. The joint part 25 is a portion that is included in the lip part 22, which is made of the soft material, and is in contact with the leg part 12, which is made of the hard resin. At the time of formation of the lip part 22, part of the lip part 22 is embedded in the recesses of the leg part 12, so that protrusions and recesses are formed to the joint part 25. The protrusions and recesses of the joint part 25 may be equally spaced in the circumferential direction of the lip part 22.

Thus, in response to the number of alternate protrusions and recesses, the joint part 25 of the lip part 22 increases the area of contact with the bracket body section 11. Then, the joint part 25 of the lip part 22 raises the strength at which the lip part 22 is joined to the bracket body section 11 to inhibit the lip part 22 from being detached from the bracket body section 11.

The first parting line 26 has an annular shape over the entire circumference of the lip part 22. The first parting line 26 corresponds to a step formed due to division of a mold for forming the lip part 22, The second parting line 27 is linear in shape and extends in the radial direction of the lip part 22. The second parting line 27 also corresponds to a step formed due to division of the mold for forming the lip part 22.

As illustrated in FIG. 4, the lip part 22 includes a lip distal part 22T and a lip base part 22B. The lip distal part 22T is a portion that is included in the lip part 22 and is closer to the distal end of the lip part 22 than the first parting line 26 is. The lip base part 22B is a portion that is included in the lip part 22 and is closer to the base end of the lip part 22 than the first parting line 26 is, and includes the joint part 25. The first parting line 26 corresponds to the boundary between the lip distal part 22T and the lip base part 22B.

The lip distal part 22T includes no parting line on its face for contact with the attachment panel 31. The lip distal part 22T including no parting line has, as the face for contact with the attachment panel 31, a smooth face 22TS continuous in the circumferential direction of the lip part 22. The smooth face 22TS includes, on its portion in contact with the lip base part 22B, a smooth convex face that gradually protrudes toward the body seal part 23 with respect to the lip part 22 (refer to FIG. 5).

The second parting line 27 is disposed only in the lip base part 22B. The second parting line 27 is disposed in a protrusion adjacent to a fastening part 13 in the circumferential direction of the leg part 12 from among the protrusions in the projections and recesses of the joint part 25. Two second parting lines 27 are disposed per fastening part 13 such that each fastening part 13 is interposed between the corresponding second parting lines 27 in the circumferential direction of the leg part 12. The leg part 12 includes no stopper 18 between each fastening part 13 and each of the corresponding second parting lines 27 in the circumferential direction of the leg part 12. A set of two second parting lines 27 per fastening part 13 is interposed between the corresponding stoppers 18 in the circumferential direction of the leg part 12 (refer to FIG. 3).

The lip base part 22B including the second parting lines 27 enables achievement of sliding of the molds divided for forming the lip base part 22B. The divided molds for molding the second parting lines 27 each correspond to a mold for molding a fastening part 13 in the leg part 12, The amount of protrusion of each protrusion in the protrusions and recesses of the joint part 25 is almost equal to the minimum width of the lip base part 22B. The width of the lip base part 22B corresponds to the length of the lip base part 22B in a direction orthogonal to the circumferential direction of the lip part 22.

As illustrated in FIG. 5, the attachment panel 31 through which the leg part 12 is inserted abuts on the stoppers 18 through the surface of the attachment panel 31. The slope of each fastening part 13 inserted through the insertion hole of the attachment panel 31 presses the back face of the attachment panel 31 to the corresponding stoppers 18 to position the leg part 12 to the attachment panel 31. The in-vehicle bracket having the leg part 12 positioned has the lip distal part 22T in contact with the surface of the attachment panel 31. The lip distal part 22T in contact with the surface of the attachment panel 31 bends along the surface of the attachment panel 31 by the amount of pushing due to the surface of the attachment panel 31.

In this case, the relative position of the leg part 12 to the surface of the attachment panel 31 is determined in advance by the fastening parts 13 and the stoppers 18. In addition, the relative position of the lip distal part 22T to the surface of the attachment panel 31 is determined in advance based on the relative position of the stoppers 18 to the lip distal part 22T. Then, a contact part 22W, as a portion for contact with the surface of the attachment panel 31, in the lip distal part 22T is determined in advance based on the relative position of the stoppers 18 to the lip distal part 22T, Thus, the lip distal part 22T effects waterproofing between the attachment panel 31 and the bracket body section 11, Then, the reproducibility of waterproofing due to the lip distal part 22T rises in accordance with the size of the contact part 22W of the lip part 22 determined in advance based on the relative position of the stoppers 18 to the lip distal part 22T.

As illustrated in FIG. 5, the leg part 12 includes a reception part 19. The reception part 19 is provided all over in the circumferential direction of the leg part 12. The reception part 19 corresponds to a portion protruding outward from the leg part 12. The reception part 19 has a slope in contact with the body seal part 23. The slope of the reception part 19 is angled with respect to the extending direction of the leg part 12. The reception part 19 extends to the lip base part 22B. Note that, in the first embodiment, the stoppers 18 also extend to the lip base part 22B.

### Formation of Lip Part 22

As illustrated in FIG. 6, the in-vehicle bracket is produced by double molding using hard material and soft material. A mold for molding the in-vehicle bracket includes a body mold 51, a plurality of lip base molds 52, a body seal mold 53, and a single lip distal mold 54.

The body mold 51 molds the inner face of the leg part 12 of the bracket body section 11 and the inner face of the flange part 11A. The lip base molds 52 mold the outer face of the leg part 12 of the bracket body section 11 and the structure of the lip base part 22B for facing the attachment panel 31. The body seal mold 53 molds the outer face of the flange part 11A of the bracket body section 11 and the outer face of the body seal part 23. The lip distal mold 54 molds the entire lip distal part 22T.

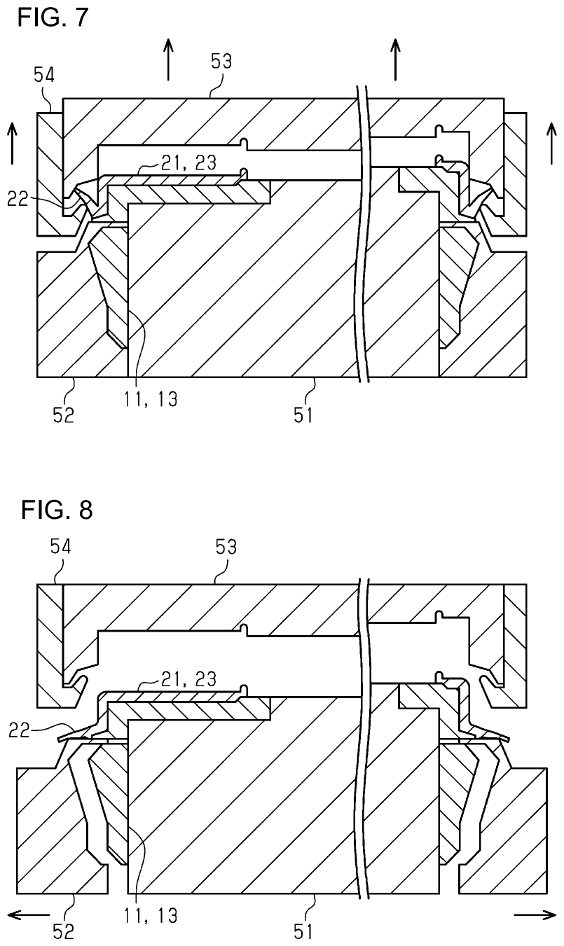

As illustrated in FIG. 7, for demolding the in-vehicle bracket, first, the body seal mold 53 and the lip distal mold 54 are separated from the in-vehicle bracket along the extending direction of the leg part 12. In this case, the lip distal part 22T of the lip part 22 is forcedly ejected from the lip distal mold 54. Thus, the lip distal part 22T including no parting line on its face for contact with the attachment panel 31 is molded. In addition, the first parting line 26, which is the boundary between the lip distal part 22T and the lip base part 22B, is formed. In addition, a smooth convex face that gradually protrudes toward the body seal part 23 with respect to the lip part 22 is formed on the portion, in the smooth face 22TS, in contact with the lip base part 22B. Note that, in order to forcedly eject the lip distal part 22T, the lip distal mold 54 bends the lip distal part 22T while lifting the lip distal part 22T in the extending direction of the leg part 12.

As illustrated in FIG. 8, for demolding the in-vehicle bracket, next, the lip base molds 52 are separated from the in-vehicle bracket along the radial direction of the leg part 12. Thus, together with the lip base part 22B including the second parting lines 27 on its face for contact with the attachment panel 31, the fastening parts 13 are molded by some of the lip base molds 52 and the stoppers 18 are molded by the other lip base molds 52. In addition, the lip base part 22B is joined to the bracket body section 11 through the joint part 25 including protrusions and recesses. Then, the lip part 22 including the first parting line 26 and the second parting lines 27 is molded together with the bracket body section 11.

### Effects

According to the first embodiment described above, the following effects are obtained.
(1) The lip part 22 of the seal section 21 effects waterproofing between the flange part 11A of the bracket body section 11 and the attachment panel 31. The first attachment hole formed on the body seal part 23 is disposed on the seal section 21 such that the seal section 21 effects waterproofing between the flange part 11A and the nozzle 33 for camera cleaning. The second attachment hole formed on the body seal part 23 is disposed on the seal section 21 such that the seal section 21 effects waterproofing between the flange part 11A and the in-vehicle camera 34.

As above, the seal section 21 integrated with the bracket body section 11 effects waterproofing between the flange part 11A and the attachment panel 31 and between the flange part 11A and each in-vehicle device. In particular, since the seal section 21 effects waterproofing between the flange part 11A and each in-vehicle device, the sealing performance of the in-vehicle bracket is high. Since such a single seal section 21 effects waterproofing between the flange part 11A and the attachment panel 31 and between the flange part 11A and each in-vehicle device, the number of members required for waterproofing can also be reduced.
(2) In a case where the seal section 21 is integrally formed with the bracket body section 11, a gap is hardly formed between the bracket body section 11 and the seal section 21. Thus, the sealing performance between the bracket body section 11 and the seal section 21 is high. The operation of attaching each in-vehicle device to the attachment panel 31 through the in-vehicle bracket also serves as the operation for waterproofing between the attachment panel 31 and the in-vehicle bracket and between the in-vehicle bracket and each in-vehicle device. As a result, the in-vehicle bracket is easily handled, in comparison to a case where the bracket body section 11 is a member separate from the seal section 21.
(3) In a case where the seal section 21 includes the first crimp part 234 that protrudes to be crimped to the nozzle 33 for camera cleaning, the waterproofing between the nozzle 33 for camera cleaning and the flange part 11A is enhanced by the first crimp part 234.
(4) In a case where the seal section 21 includes the second crimp part 235 that protrudes to be crimped to the in-vehicle camera 34, the waterproofing between the in-vehicle camera 34 and the flange part 11A is enhanced by the second crimp part 235.
(5) In a case where the lip part 22 is disposed closer to the flange part 11A than the fastening parts 13, the lip part 22 is easily pressed against the surface of the attachment panel 31 with the leg part 12 attached to the attachment panel 31. Thus, the sealing performance due to the lip part 22 between the flange part 11A and the attachment panel 31 is high.
(6) The sealing performance due to the lip part 22 between the flange part 11A and the attachment panel 31 is higher in a case where the lip distal part 22T includes no parting line on its face for contact with the attachment panel 31 than in a case where the lip distal part 22T includes a parting line.
(7) In a case where the boundary between the lip base part 22B and the lip distal part 22T is the first parting line 26 annular in shape, for demolding the lip distal part 22T, forced ejection, such as ejection of the lip distal part 221 from the mold along the outer shape of the lip distal part 22T, can be performed.
(8) In a case where the lip base part 22B includes the second parting lines 27, for demolding the lip base part 22B, sliding of the divided molds along the outer shape of the lip base part 22B can be performed. Thus, a reduction is made in design load for the lip distal part 22T requiring forced ejection.
(9) In a case where the joint part 25 includes alternate protrusions and recesses in the circumferential direction of the flange part 11A, in the joint part 25, the area of contact with the bracket body section 11 increases. Thus, the strength at which the lip part 22 is joined to the bracket body section 11 increases.

### Second Embodiment

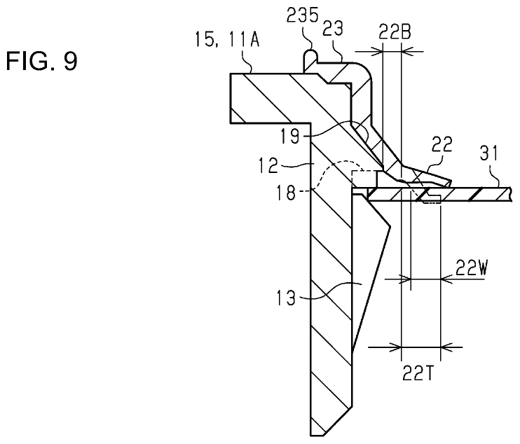

An in-vehicle bracket according to a second embodiment will be described with reference to FIG. 9. Duplicate descriptions in configuration between the in-vehicle bracket according to the first embodiment and the in-vehicle bracket according to the second embodiment will be omitted.

A structure may be provided between a leg part 12 and a lip part 22 such that the leading end of a reception part 19 is disposed outside the leading ends of stoppers 18 and a step in the up-down direction is provided between the lower face of the reception part 19 and the lower face of each stopper 18. That is, the stoppers 18 do not extend to a lip base part 22B, unlike those in the first embodiment. In other words, since the reception part 19 extends to the lip base part 22B but the stoppers 18 do not extend to the lip base part 22B, the leading end of the reception part 19 is disposed outside the leading ends of the stoppers 18.

According to the second embodiment described above, the following effects are obtained.

Since the lip base part 22B is away outward from the stoppers 18, the boundary between the lip base part 22B and the leg part 12 is determined all over in the circumferential direction by the reception part 19. As a result, the base end in the bendable area of the lip part 22 is determined all over in the circumferential direction by the reception part 19. In addition, in a case where an attachment panel 31 abuts on the stoppers 18, the interval in the up-down direction between the attachment panel 31 and the lip base part 22B is constant all over in the circumferential direction. Thus, the stress against bending acting on the lip base part 22B is inhibited from varying in the circumferential direction, so that the surface pressure acting on the lip distal part 22T is uniform in the circumferential direction while inhibiting the partial reducing in the circumferential direction.

### Modifications

The first and second embodiments described above can each be carried out in the following modified modes.

In addition to the circumferential direction of the flange part 11A, the joint part 25 may include alternate protrusions and recesses in the extending direction of the leg part 12 or in a direction crossing the extending direction of the leg part 12 and the circumferential direction of the flange part 11A. Each protrusion in the protrusions and recesses of the joint part 25 and each recess disposed on the outer circumferential face of the leg part 12 may be each smaller in size than each fastening part 13 or may be each larger in size than each fastening part 13.

The recesses for giving protrusions and recesses to the joint part 25 on the outer circumferential face of the leg part 12 may be omitted. In this case, without protrusions and recesses, the joint part 25 may be shaped like a band that extends in the circumferential direction of the leg part 12. Even with this configuration, effects similar to the above-described effects in (1) to (8) are obtained.

The lip part 22 may include no first parting line 26. In this case, the lip distal part 22T may include a plurality of parting lines arranged side by side in the circumferential direction of the flange part 11A, like the lip base part 22B. Even in a case where the lip distal part 22T includes such parting lines, effects similar to the above-described effects in (1) to (6) and (9) are obtained.

The flange part 11A may be shaped like a bowl that covers part of the outer circumferential face of the leg part 12. In this case, the lip part 22 that expands around the flange part 11A may be disposed on the side opposite to the side of the flange part 11A to the fastening parts 13 in the extending direction of the leg part 12, As described above, the attachment panel 31 has a portion for contact with the lip part 22 and a portion to be fastened by each fastening part 13, which are mutually different. Thus, the relative position of the lip part 22 to the fastening parts 13 in the extending direction of the leg part 12 can be changed as appropriate in accordance with the shape of the attachment panel 31. Note that, in a case where the attachment panel 31 is planar in shape around its hole for insertion of the leg part 12, the lip part 22 may be disposed closer to the flange part 11A than the fastening parts 13. According to this configuration, an effect similar to the above-described effect in (5) is obtained.

The first crimp part 234 does not necessarily protrude and the second crimp part 235 does not necessarily protrude. In this case, the body seal part 23 may be planar in shape, include, around the first attachment hole, a recess to be crimped to the nozzle 33 for camera cleaning, or include, around the second attachment hole, a recess to be crimped to the in-vehicle camera 34. For waterproofing between each in-vehicle device attached to the bracket body section 11 and the flange part 11A, the body seal part 23 is required to have a structure for contact with the in-vehicle devices.

A waterproof part is not limited to the lip part 22 including the lip base part 22B and the lip distal part 22T and thus may be an annular body circular in section or a belt-like body rectangular in section that is disposed around the flange part 11A and has waterproof performance and elasticity for waterproofing between the flange part 11A and the attachment panel 31.

An attachment hole may expose, with an attachment part not exposed from the seal section 21, the remainder of the flange part 11A excluding the attachment part through the attachment hole to assist attachment of an in-vehicle device to the attachment part. The exposed part of the flange part 11A through the attachment hole may function for positioning the in-vehicle device or function as a path for wiring the in-vehicle device.

### REFERENCE SIGNS LIST

11 Bracket body section
11A Flange part
12 Leg part
13 Fastening part
14 First attachment part
14H First insertion hole
15 Second attachment part
15H Second insertion hole
19 Reception part
21 Seal section
22 Lip part
23 Body seal part
22B Lip base part
22T Lip distal part
25 Joint part
26 First parting line
27 Second parting line
31 Attachment panel

1. An in-vehicle bracket for attaching an in-vehicle device to an attachment panel of a vehicle, the in-vehicle bracket comprising:
a bracket body section; and
a seal section made of soft material, the seal section being integrated with the bracket body section, wherein
the bracket body section includes:
a flange part including an attachment part configured to allow the in-vehicle device to be attached to the attachment part; and
a leg part including a fastening part configured to be attached to the attachment panel, the leg part extending from the flange part, and
the seal section
is configured to cover the flange part and expand around the flange part, and
includes:
a waterproof part disposed around the flange part to effect waterproofing between the flange part and the attachment panel; and
a crimp part having an attachment hole for attaching the in-vehicle device to the attachment part, the crimp part being disposed to effect, around the attachment hole, waterproofing between the flange part and the in-vehicle device.

2. The in-vehicle bracket according to claim 1, wherein the crimp part and the waterproof part in the seal section are integrally formed.

3. The in-vehicle bracket according to claim 1, wherein the crimp part is disposed over an entire circumference of the attachment hole and protrudes to be crimped to the in-vehicle device.

4. The in-vehicle bracket according to claim 1, wherein the waterproof part is disposed closer to the flange part than the fastening part in an extending direction of the leg part.

5. The in-vehicle bracket according to claim 1, wherein the waterproof part is a lip part including:
a lip base part joined to the bracket body section; and
a lip distal part extending from the lip base part to outward of the bracket body section,
the lip distal part has a face for contact with the attachment panel, the face having no parting line, and
a boundary between the lip base part and the lip distal. part is an annular parting line that surrounds the flange part at a portion facing the attachment panel.

6. The in-vehicle bracket according to claim 5, wherein the lip base part has, in a portion to face the attachment panel, parting lines arranged side by side in a circumferential direction of the flange part.

7. The in-vehicle bracket according to claim 1, wherein
the waterproof part is a lip part including:
a lip base part jointed to the bracket body section; and
a lip distal part extending from the lip base part to outward of the bracket body section, and
a joint part of the lip base part to the bracket body section includes alternate protrusions and recesses in a circumferential direction of the flange part.

8. The in-vehicle bracket according to claim 1, wherein
the leg part includes a plurality of stoppers arranged side by side in a circumferential direction of the leg part, the stoppers protruding outward at an outer circumferential face of the leg part, the stoppers being configured to determine a relative position of the leg part to a surface of the attachment panel,
the waterproof part is a lip part including:
a lip base part jointed to the bracket body section; and
a lip distal part extending from the lip base part to outward of the bracket body section,
the leg part includes a reception part provided all over in the circumferential direction of the leg part, the reception part extending to the lip base part, and
the stoppers do not extend to the lip base part with the reception part extending to the lip base part, whereby a leading end of the reception part is disposed outside leading ends of the stoppers.
